(19) United States
(12) Patent Application Publication
(10) Pub. No.: US 2016/0247293 A1
(43) Pub. Date: Aug. 25, 2016

(54) MEDICAL IMAGING SYSTEMS AND METHODS FOR PERFORMING MOTION-CORRECTED IMAGE RECONSTRUCTION

(71) Applicants: Brain Biosciences, Inc., Rockville, MD (US); University of Maryland, Baltimore, Baltimore, MD (US)

(72) Inventors: David Beylin, Bethesda, MD (US); Sergey Anishchenko, North Potomac, MD (US); Mark F. Smith, Catonsville, MD (US); Pavel Stepanov, North Potomac, MD (US); Alex Stepanov, North Potomac, MD (US); Valery Zavarzin, Newton, MA (US); Stephen Schaeffer, Ellicott City, MD (US); Irving N. Weinberg, Bethesda, MD (US)

(21) Appl. No.: 15/052,376

(22) Filed: Feb. 24, 2016

Related U.S. Application Data
(60) Provisional application No. 62/119,971, filed on Feb. 24, 2015.

(51) Int. Cl. G06T 7/20; G06T 11/00; G06T 7/00

(52) U.S. Cl. CPC G06T 7/2086; G06T 7/0016; G06T 11/005; G06T 7/2033; G06T 7/002; G06T 2207/10021; G06T 2207/10104

(57) ABSTRACT

A system and method to perform motion tracking and motion-corrected image reconstruction in the field of medical imaging in general and Positron Emission Tomography in particular.

This application relies for priority on U.S. Provisional Patent Application Ser. No. 62/119,971, entitled “MEDICAL IMAGING SYSTEMS AND METHODS FOR PERFORMING MOTION-CORRECTED IMAGE RECONSTRUCTION” filed on Feb. 24, 2015, the entirety of which being incorporated by reference herein.

### FIELD

Disclosed embodiments relate to medical imaging technology. Further, disclosed embodiments related to the motion tracking technology and image processing and reconstruction technologies.

### BACKGROUND

Positron Emission Tomography (PET) is an important and widely used medical imaging technique that produces a three-dimensional image of functional processes in the body. PET is used in clinical oncology, for clinical diagnosis of certain brain diseases such as those causing various types of dementias, and as a research tool for mapping human brain and heart function.

A typical clinical brain PET data acquisition (PET scan) lasts about 10 minutes while a research PET scan can last much longer. Often it is difficult for patients to stay still during the duration of the scan. Especially, children, elderly patients and patients suffering from neurological diseases or mental disorders have difficulty staying still during the duration of the scan. Unintentional head motion during PET data acquisition can degrade PET image quality and lead to artifacts. Poor patient compliance, head tremor, body repositioning, breathing, and coughing are sources of movement. Head motion due to patient non-compliance with technologist instructions becomes particularly common with the evolving role of amyloid brain PET in dementia patients.

There are four conventionally known strategies for decreasing the influence of motion in PET brain imaging. The first one is the use of a physical head restraint, while a second one is the use of pharmacological restraint, e.g., sedatives. Although, these approaches can minimize head movement, they may not be well tolerated by the patient. Alternatively, a third approach is to correct motion by reconstructing separate image frames within a study and then realigning these image frames to a template, which can be a single emission or transmission scan. This approach is also referred to as a “data-driven” approach. The fourth strategy utilizes motion tracking during the scan using other sensing or imaging techniques (e.g., optical). This motion information can be used to realign reconstructed frame-mode PET images or to reorient the positions of lines of responses (LOR) during list mode image reconstruction (event-driven approach).

It has been shown that motion tracking methods are superior to a data-driven approach (see e.g., Montgomery et al., Correction of head movement on PET studies: comparison of methods, Journal of Nuclear Medicine 47 (12), 1936-1944, 2006). Besides motion correction, using tracking systems enables registration of either the PET images acquired in a set of consecutive studies or emission and transmission scans, without the use of image based registration methods.

### SUMMARY

Motion tracking can be facilitated by using fiducial markers attached to the object to be imaged (e.g., the head of a patient). However, attaching fiducial markers on a patient's head may cause discomfort, be accidentally detached from the patient body, or have other disadvantages. Thus, it is believed that a contactless approach would be preferable. The present disclosure presents a system and a method for performing motion-corrected medical imaging employing contactless motion tracking.

Disclosed embodiments provide a system for performing motion-corrected imaging of an object. Disclosed embodiments also provide a method for performing motion-corrected imaging of an object.

Additional features are set forth in the description which follows, and in part will be apparent from the description, or may be learned by practice of the disclosed embodiments.

It is to be understood that both the foregoing general description and the following detailed description are exemplary and explanatory and are intended to provide further explanation of the disclosed embodiments.

### BRIEF DESCRIPTION OF THE DRAWINGS

The above and other aspects, features and advantages of the disclosed embodiments will be more apparent from the following detailed description taken in conjunction with the accompanying drawings in which:

FIG. 1 is a view showing an imaging system for performing motion-corrected imaging of an object according to a disclosed embodiment.

FIG. 2 shows a photograph of an imaging system for performing motion-corrected imaging of an object according to a disclosed embodiment.

FIG. 3 is a view of a diagram depicting a method for performing motion-corrected imaging according to a disclosed embodiment.

FIGS. 4A-4C illustrate a mockup of a portable brain PET scanner used to investigate and validate technical utility of an exemplary implementation of a system designed in accordance with the disclosed embodiments.

FIGS. 5A-5C illustrate an example of evaluation of performance of a motion tracking system and a PET scan performed with a moving American College of Radiology (ACR) phantom.

FIGS. 6A-6B include a graph of the X coordinate (dark) and the ground truth (light) for a representative facial point determined in experimental evaluation of an exemplary implementation of a system designed in accordance with the disclosed embodiments.

FIGS. 7A-7C illustrate an example of independently reconstructed PET images from acquisitions with different rotations gathered as part of experimental evaluation of an exemplary implementation of a system designed in accordance with the disclosed embodiments.

FIGS. 8A-8B illustrates combination of the images were combined into one image without motion compensation (FIG. 8A). There is obvious blurring in this image. The six degree of freedom pose information from the stereo motion tracking system was used for aligning images to the initial position of the phantom. The aligned images were combined into one with compensated motion (FIG. 8B).

### DETAILED DESCRIPTION

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

At least one disclosed embodiment discloses a medical imaging system including an imaging apparatus, a marker-less tracking system, an image correction and image forming unit. The imaging apparatus may be a PET scanner. The imaging apparatus may be configured to acquire a plurality of data points (e.g., Lines Of Responses or LORs) or image frames corresponding to events taking place in an object disposed in the PET scanner (i.e., perform a PET scan). The tracking system may include two pairs of stereo cameras configured to take sequences of images (e.g., video) of the object during the PET-scan. The tracking system may be configured to determine the position and motion of the object, with respect to the PET scanner, during the PET scan. The image correction and image forming unit may receive the data points or image frames from the PET scanner and data describing the motion of the object from the tracking system. The image correction unit may correct the data points or the image frames such as to remove the artifacts due to the motion of the object during the PET scan. The final motion-corrected image of the object may be obtained by using the corrected data points (e.g., LORs) in an image reconstruction algorithm and/or combining the reconstructed image frames.

A disclosed embodiment includes a medical imaging method including calibrating and synchronizing the PET scanner and the cameras, placing the object to be imaged in the imaging-volume of a PET scanner, PET scanning of the object, continuously tracking the motion of the object during the PET scan, correcting individual frames and LORs for the motion of the object and forming a motion-corrected image of the object.

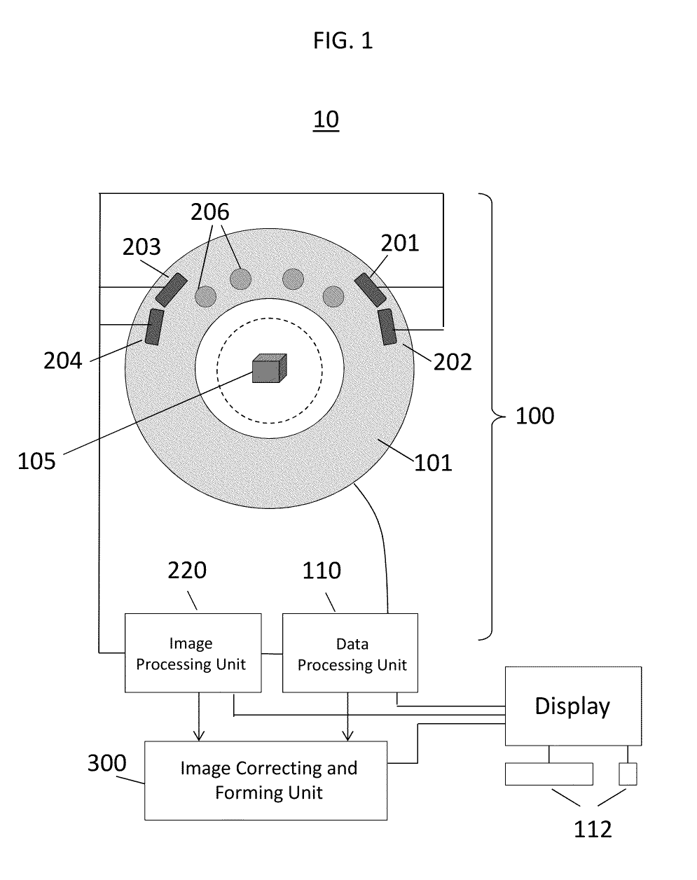

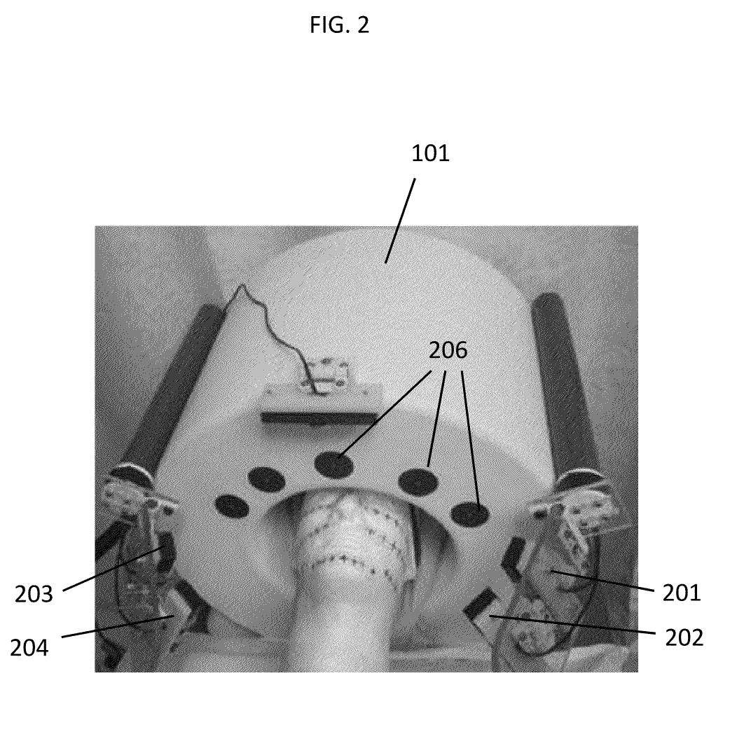

More specifically, as illustrated in FIGS. 1-2, a motion-corrected imaging system 10 for performing motion-correction imaging of objects is provided according to a first disclosed embodiment, with reference to FIGS. 1 and 2. The motion-corrected imaging system 10 may include an imaging system 100, a tracking system (including cameras 201-204 and markers 206) for tracking a position of an object, and an image correction unit 300.

The imaging system 100 may be any one or a combination of nuclear medicine scanners, such as: a conventional PET, a PET-CT, a PET-MRI, a SPECT, a SPECT-CT, and a SPECT-MRI scanner. For the sake of clarity, various embodiments and features described herein make reference to a system including a conventional PET scanner, as shown in FIGS. 1 and 2. However, it is to be understood that the disclosed embodiments apply to any of the imaging systems mentioned above.

The imaging system 100 may include a conventional PET scanner 101. Further, the PET scanner may include or may be connected to a data processing unit 110. The data processing unit 110 may include a computer system, one or more storage media, and one or more programming modules and software.

The PET scanner may have a cylindrical shape, as shown in FIGS. 1-2, including an imaging volume in the bore of the cylinder. The imaging system 100 may be configured to perform imaging of an object 105 disposed in the imaging volume. The object 105 may be a head of human, an animal, a plant, a phantom, etc. However, the disclosed embodiments are not limited by the type of object which is imaged.

The PET scanner is configured to acquire imaging-data corresponding to a plurality of radioactivity events (e.g., emission of positrons, emissions of gamma rays, etc.) taking place inside the object. The data processing unit 110 may be configured to receive the imaging data and to perform data processing. The data processing unit 110 may also be configured to extract from the imaging-data a sequence of data-points corresponding to individual events, wherein each such data-point includes, for example: (1) information about the spatial position of the event such as the positions of the line of responses (LOR); and (2) information regarding the timing of the event, which may be the time when a gamma ray corresponding to the event is detected by a detector of the PET scanner.

The spatial position of the events may be described with reference to a frame attached to the PET scanner. The PET scanner reference frame may be an orthonormal system R1 (x₁-axis, y₁-axis, z₁-axis) with an origin that is positioned in a center of the imaging-volume, has the z-axis disposed along the axis of the PET scanner, a horizontal x-axis, and a vertical y-axis. The timing of the events may be described with respect to a timer of the PET scanner. Thus, an event may be described, with respect to the PET scanner reference frame, by the spatial-temporal coordinates (x, y, z, t).

Further, the data processing unit 110 may be configured to use the sequence of data-points to generate one or more images corresponding to the events and the corresponding object (e.g., typically the events take place inside the object). The PET scanner may acquire the sequence of data-points over a certain time period (hereinafter referred as “PET scan-period”). The PET scan-period may be adjusted so as to optimize the imaging process.

The data processing unit 110 may be configured to receive imaging-data from the PET scanner essentially in real time. The scan-period may include a sequence of time-intervals. For each time-interval, the processing unit 110 may be configured to form an image (i.e., a frame) corresponding to the sequence of data-points received during that time-interval which, in turn, may correspond to a sequence of events taking place in the time-interval. Thus, the processing unit 110 may form a sequence of frames corresponding to the sequence of time-intervals. The data processing unit 110 may be configured to use the sequence of frames to form a final-image corresponding to all events detected during the scan-period.

The computer system may be configured to display the formed images on a display and/or to create a hard copy of the images such as by printing said images. The computer system may include one or more input devices 112 (e.g., keyboard, mouse, joystick) enabling operators of the PET scanner and imaging staff to control the acquisition, processing and analysis of the imaging-data. Further, the input devices 112 may enable operators and imaging staff to control the forming of the images and to perform image analysis and processing.

The PET scanner may be a portable PET brain scanner such as the CerePET™ scanner under development by Brain Biosciences, Inc.

The tracking system for tracking a position of the object may include a plurality of cameras (e.g., 201-204 in FIGS. 1-3) connected with a computer system. The cameras may be rigidly attached to the PET scanner 101 such that their position with respect to each other and with respect to the PET scanner is maintained constant even when the imaging system 10 is moved (e.g., the imaging system may be a portable system). The cameras may have a defined position with respect to each other and with respect to the PET scanner. The cameras may be disposed such as to obtain images of an object (e.g., a head) disposed inside the PET scanner in the imaging-volume.

The plurality of cameras may comprise any number of cameras, such as two cameras, three cameras, four cameras, five cameras, six cameras. In at least one embodiment, the tracking system includes four cameras as shown by 201-204 in the disclosed embodiment of FIG. 1.

Each of the four cameras 201-204 may be configured to acquire a corresponding sequence of images of the object (e.g., a video) during a time-period. The first, second, third and fourth cameras may be configured to acquire a first, second, third and fourth sequences of images (e.g., videos) of the object, respectively. The time-period may include a first period prior to the PET scan-period, a second period including the PET scan-period, and a third period after the PET scan-period. The images in the sequences of images may be collected during a plurality of video-frames.

The computer system may include one or more storage media (e.g., hard drives, solid state memories, etc.), and one or more computers, one or more input devices, a display, and software stored on the storage media, and an image processing system 220. The computer system may be configured to receive the first to fourth sequences of images (e.g., videos) from the first to fourth cameras. The computer display may be configured to display the sequences of images collected by the cameras, in real time, such that an operator (e.g., imaging staff) may view and analyze the sequences of images.

The image processing system 220 may determine (from the first, second, third and fourth sequences of images) the sequence of positions of the object corresponding to the movement of the object during the PET scan-time (i.e., perform tracking of the object) by tracking one or more markers attached to the object or by tracking intrinsic features of the object (i.e., markerless tracking).

In a first disclosed embodiment the marker-less tracking of intrinsic features may include the selection of the intrinsic-features (i.e., also referred as reference-points) to be tracked by the operator. One or more of the images collected by the cameras may be displayed on a display. The one or more input devices and the software may enable an operator to select (e.g., via mouse click on the displayed image) one or more intrinsic-features on images of the sequences (e.g., a tip of the nose, a tip of the chin, a point on the jaw etc.). Then, the tracking system follows/tracks the intrinsic-features by determining the position of said intrinsic-features in subsequent images of the sequences, thereby determining the position/movement of the intrinsic-features during the scan-time. In other words, the operator may hand-pick intrinsic features on each person/animal/object and track these points in time. The positions of the intrinsic-features may be first determined in reference frames of the cameras. Then, the image processing system 220 may determine the positions of the intrinsic-features in the frame of the PET-scanner (easily determined since the cameras are rigidly attached to the PET-scanner).

In a disclosed embodiment the tracking system may be configured to follow three intrinsic-features, selected by the operator, on the surface of the object. However, the disclosed embodiments are not limited by the number of intrinsic-features selected by the operator and tracked by the tracking system. The operator may select any number of intrinsic-features and the tracking system may follow any number of such intrinsic-features.

In a second disclosed embodiment the marker-less tracking of intrinsic-features may include the automatic identification of the features to be tracked and may not need an operator to select intrinsic-features. The image processing system 220 may include software configured to extract from the images a plurality of anatomical/structural points and features (e.g., a tip of the nose, a tip of the chin, a point on the jaw etc.) and to associated reference-points to said anatomical/structural points, thereby automatically identifying the intrinsic-features to be tracked. Then, the tracking system follows/tracks the intrinsic-features, thereby determining the position/movement of the intrinsic-features during the imaging period. In at least one disclosed embodiment the tracking system may be configured to find and follow three intrinsic-features on the surface of the object. However, the disclosed embodiments are not limited by the number of intrinsic-features tracked and the tracking system may follow any number of such intrinsic-features.

The image processing system 220 is configured to extract/determine, from the determined positions and movement of the intrinsic-features, a sequence of positions of the object corresponding to the movement of the object during the PET scan-period. Thereby the image processing system 220 determines a motion of the object during the scan-time. The extracted positions of the object may be described by six degrees of freedom corresponding to an object which is a rigid body. The six degrees of freedom may be expressed in one or more coordinate systems.

In at least one disclosed embodiment, an orthogonal coordinate system of axes R2 (x₂-axis, y₂-axis, z₂-axis) is rigidly associated with the object such that the origin of the axes is disposed in the center of the object (R2 may be an object reference frame). The intrinsic-features on the object have a fixed/stationary position in the R2 frame since the object is stationary in the R2 frame (the positions and movement of the intrinsic-features with respect to the R1 frame have been determined, as explained above). The stationary positions of the intrinsic-features with respect to the R2 axes may be determined. Further, the positions and movement of the R2 axes may be determined from the positions and movement of the intrinsic-features.

The position and movement of the object may be described with respect to the PET scanner reference frame R1 by specifying the position of the R2 axes with respect to the axes of R1. The position of the R2 axes with respect to the R1 axes may be expressed as three translations and three rotations as is customary in the field of dynamics/mechanics of the rigid body. An event may be recorded at a position (x1, y1, z1, t) in the R1 frame and a position (x2, y2, z2, t) in the R2 frame. The coordinates (x2, y2, z2, t) of the event in the R2 system may be determined from the coordinates (x1, y1, z1, t) via the transformation operator A(t), linking the R1 and R2 axes, such as: (x2, y2, z2, t)=A(t){(x1, y1, z1, t)}. Thus the movement of the object may be described by the time dependent operator A(t). The operator “A(t)” describing the position of the orthogonal system R2 (i.e., the object) at time “t” with respect to the R1 system may be determined by using the three translations and three rotations at the time “t”. The determination of the A(t) operator from the extracted positions of the object is well known in the imaging and rigid body dynamics fields. The image processing system 220 may employ a rigid body transform in order to make the determination of the motion more robust. The artisan would understand that the orthogonal systems of axes and the reference frames mentioned in this disclosure are only mathematical constructions without any material form.

The tracking system may include a position calibration system configured to find the position of the cameras with respect to each other and with respect to the PET machine. The tracking system may derive 3-D tracking point locations in the stereo camera reference frame (rigid body motion) and the motion of the person/animal/object in the PET scanner reference frame (e.g., 6 degrees of freedom: 3 translational, 3 rotational). The tracking system may further include one or more markers 206 rigidly attached to or disposed on the PET imaging machine. The markers may be in the field of view of at least some of the cameras. The calibration system may use the images of the markers 206 to calibrate the position of the cameras with respect to the PET scanner.

The four cameras may include a first stereo pair including cameras 201-202 and a second stereo pair including cameras 203-204. The inventors have found that the stability of the tracking system is significantly improved when the four cameras are stereo pairs disposed as described herein. The cameras 201-202 may be disposed on one side of the PET scanner while the cameras 203-204 may be disposed on the other side of the PET scanner as shown in FIG. 1. The first pair of cameras may be disposed to collect images of a first side of an object (e.g., head) disposed inside the PET scanner whereas the second pair of cameras may be disposed such as to collect images of a second side of the object (e.g., head). A distance between cameras in the pairs (i.e., the distance between cameras 201-202, and the distance between cameras 203-204) may be substantially smaller than the distance between pairs (as shown in FIG. 1). The first camera pair 201-202 and the second camera pair 203-204 may be disposed symmetrically with respect to a central axis of the PET scanner (as shown in FIG. 1). The first pair of stereo camera may be configured to form a first stereo 3D image of the object whereas the second pair of stereo cameras may be configured to form a second stereo 3D image of the object. The first stereo pair 201-202 may be configured to track three points on the object whereas the second stereo pair 203-204 may be configured to track other three points on the object. However, each of the stereo pairs may track more than three points.

In at least one disclosed embodiment, the image processing system 220 may use separately the data obtained from the first stereo pair 201-202 and the data obtained from the second stereo-pair 203-204 to obtain information about the motion of the object. In another disclosed embodiment, the image processing system 220 may simultaneously use the data obtained from the two stereo pairs to obtain information about the motion of the object.

The tracking system may further include a synchronization system for synchronizing the image acquisition between the cameras, a timer for timing the image sequences, and one or more light sources disposed such as to illuminate the object.

The PET image correction and image forming unit 300 may include a computer, storage media and software stored on said storage media. The image correction unit 300 may be configured to receive, in real time, imaging data (e.g., data points, image frames etc.) from the PET scanner 100 and data describing the motion of the object (e.g., the operator A(t), the time-dependent translations and rotations defining the motion of the object) during the scan from the tracking system. The image correction unit may be configured to use the object motion data in conjunction with imaging data such as to account for the movement of the imaged object during the PET scanning and to correct the PET images.

The image correction may be performed as explained in the following. The PET scanner may acquire a sequence of data points, corresponding to a plurality of radioactivity events, during the scan-period. The PET scanner may determine a line of response (LOR) corresponding to each data point. The LOR may be defined by the position of two or more points on the LOR. A point on the LOR may be described in the R1 system by (x1, y1, z1, t). The position of the LORs with respect to the R2 system rigidly attached to the object is determined, for example, by determining the positions of the points defining the LORs with respect to the R2 system. For example, the point on the LOR in the R1 system (x1, y1, z1, t) may have a corresponding position in the R2 system (x2, y2, z2, t) which may be determined according to the transformation operator A(t), linking the system of coordinates R2 and R1, as follows: (x2, y2, z2, t)=A(t){(x1, y1, z1, t)}. As explained above, the operator A(t) describes the motion of the object with respect to the R1 system and is determined by the tracking system.

Thus, the positions of the radioactive events (e.g., the LORs) taking place in the object are first determined in the R1 system. Then, the positions of the LORs are determined, as explained above or by other methods, with respect to the R2 frame rigidly attached to the object. The positions of the LORs in the R2 system are then used to reconstruct PET images (e.g., the image including all the events detected during the PET scan) thereby correcting for the motion of the object during the PET-scan.

In another disclosed embodiment, the PET scan-period may include a sequence of time-intervals which may be essentially uniformly distributed over the scan-period or which may have different durations over the scan-period. For each time-interval, the processing unit 110 forms an image (i.e., a frame) corresponding to the sequence of data-points received during that time-interval. Thus, the processing unit 110 may form a sequence of image frames corresponding to the sequence of time-intervals (the formed image frames are not yet corrected for the motion of the object). Then, PET image correction and image forming unit 300 may assign to each frame the position/motion of the object during the corresponding time interval. Further, the unit 300 may correct each of the image frames according to the position/motion of the object during the time interval when the frame was acquired. Then, the corrected frames may be combined, for example by addition, such as to form a PET image corresponding to the PET-scan.

In another disclosed embodiment the events may be recorded as a sequence of images. Motion compensated image reconstruction may be performed by correcting the images according to the derived motion information and followed by combining up the images.

Thus, the unit 300 is configured to make correction of the PET images such as to account for the motion of the object. In at least one disclosed embodiment the object is a human head and PET imaging is performed on the brain. The image correction unit may further include a synchronization system for synchronizing the image acquisition between the cameras and the PET scanner and a timer for timing the image sequences.

The motion information alone may be provided to operators of the system (e.g., the imaging staff) such that the operators can assess whether repeat imaging should be performed on the object (e.g., a patient). Such motion information may be provided to the operators even if the derived motion information is not used in image reconstruction.

In accordance with the disclosed embodiments, a method is provided for performing motion-corrected imaging.

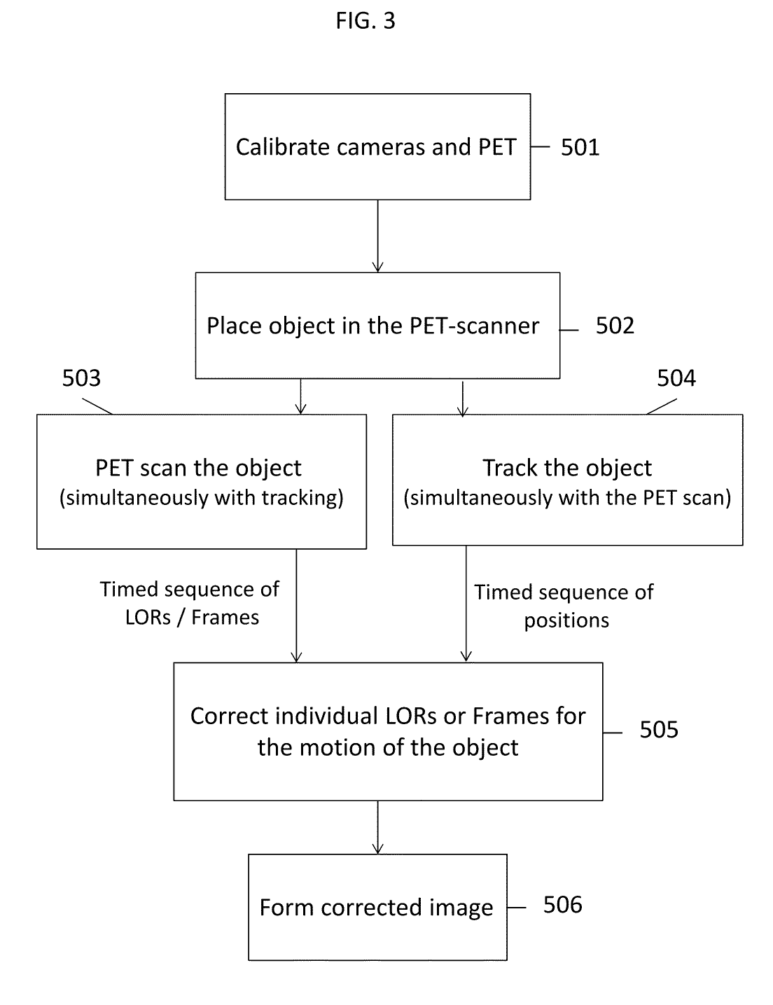

FIG. 3 illustrates such a method for performing motion-corrected imaging of objects wherein the motion-corrected imaging systems, as described above, may be used to perform motion-corrected imaging.

The method for performing motion-corrected imaging of an object disposed in an imaging-volume of a PET scanner may include: calibrating and synchronizing the PET scanner and the cameras 501; placing the object in the imaging-volume of a PET scanner 502; PET scanning of the object 503; continuously tracking the motion of the object during the PET scan 504; correcting for the motion of the object 505; and forming a motion-corrected image of the object 506.

The PET scanner and the cameras may be calibrated so as to determine a position of the cameras with respect to each other and with respect to the PET scanner. The internal clocks of the PET scanner may be synchronized with the clocks of the cameras. Subsequently, the object (e.g., a human head) may be disposed in the imaging volume of the PET scanner.

The PET scanner may then acquire imaging-data corresponding to a plurality of radioactivity events (e.g., emission of positrons, emissions of gamma rays, etc.) taking place inside the object. The data processing unit 110 may receive the resulting imaging data. The data processing unit 110 may then extract from the imaging-data a sequence of data-points including information about the spatial position of the event such as the positions of the line of responses (LOR) with respect to the PET scanner frame and information regarding the timing of the event, which may be the time when a gamma ray corresponding to the event is detected by a detector of the PET scanner. The PET scanning may be performed as explained with reference to the PET imaging system described above (i.e., the imaging system—PET scanner).

Simultaneously with performing the PET scan, the position/motion of the object may be tracked by the tracking system. The tracking system may determine the position/motion of the object (e.g., with respect to the PET frame) during the PET scan as explained above (the tracking system). The determination of the position of the object may include tracking intrinsic-features of the object (i.e., markerless tracking) and/or using the tracked position/motion of the intrinsic-features to determine the motion of a reference frame R2 rigidly attached to the object.

The PET image correction and image forming unit 300 may receive, in real time, imaging data (e.g., data points, LORs, image frames etc.) from the PET scanner 100 and data describing the motion of the object during the scan form the tracking system. The image correction unit may use the object motion data in conjunction with imaging data to account for the movement of the imaged object during the PET scanning and to correct the PET images. The image correction may be performed as explained above (with reference to the PET image correction and image forming unit) which is incorporated hereinafter in its entirety as if fully set forth herein.

The method for performing motion-corrected imaging may further include a calibration of the intrinsic optical properties of each video camera, an extrinsic calibration of each stereo camera pair to allow for 3-D localization, and a calibration of the transformation of each video camera pair to the PET scanner reference frame.

The information disclosed in the background section is only for enhancement of understanding of the context of the disclosed embodiments; therefore, it may contain information that does not form any part of the prior art.

Further, presently disclosed embodiments have technical utility in that address unintentional head motion during PET data acquisition which can degrade PET image quality and lead to artifacts. Poor patient compliance, head tremor, and coughing are examples of movement sources. Head motion due to patient non-compliance can be an issue with the rise of amyloid brain PET in dementia patients. To preserve PET image resolution and quantitative accuracy, head motion can be tracked and corrected in the image reconstruction algorithm. As explained above, while fiducial markers can be used, a contactless approach is preferable.

Thus, the disclosed embodiments utilize a video-based head motion tracking system for a dedicated portable brain PET scanner and an explanation of on exemplary implementation is now provided with associated experimental results and validation.

In the implemented exemplary implementation, four wide-angle cameras organized in two stereo pairs were used for capturing video of the patient's head during the PET data acquisition. Facial points were automatically tracked and used to determine the six degree of freedom head pose as a function of time. An evaluation of the exemplary implementation of the tracking system used a head phantom and a moving American College of Radiology (ACR) phantom. The mean video-tracking error was 0.99±0.90 mm relative to the magnetic tracking device used as ground truth. As explained herein, qualitative evaluation with the ACR phantom showed the advantage of the motion tracking application. The developed system was able to perform tracking with accuracy close to millimeter and can help to preserve resolution of brain PET images in presence of movements.

The experimental evaluation of the exemplary implementation, was performed to develop an alternative to conventional motion tracking, which can be done by either contact or contactless methods. A commercially available contact system (Polaris, Northern Digital, Inc., Waterloo, Canada) for head pose tracking utilizes passive infrared reflection from small spheres which are attached to the patient head with a neoprene hat. Movement between the hat and the scalp is normally minimized by choosing the smallest hat size that the patient can tolerate. This system is intensively used in research on motion correction but in a hospital setting it can be too time consuming for clinical staff. Some studies reported on the development of contactless systems for tracking head motion but there is no commercially available system.

Thus, the disclosed embodiments and an evaluation of an exemplary implementation were performed to develop and investigate a video-based approach for contactless tracking of head motion for a dedicated portable PET brain imaging device (Brain Biosciences Inc., Rockville, Md., USA). Accordingly, experimental analysis aimed to evaluate the precision and accuracy of the tracking system designed in accordance with the disclosed embodiments using a head phantom as well as to evaluate the application of the tracking method to a PET scan of a moving ACR phantom.

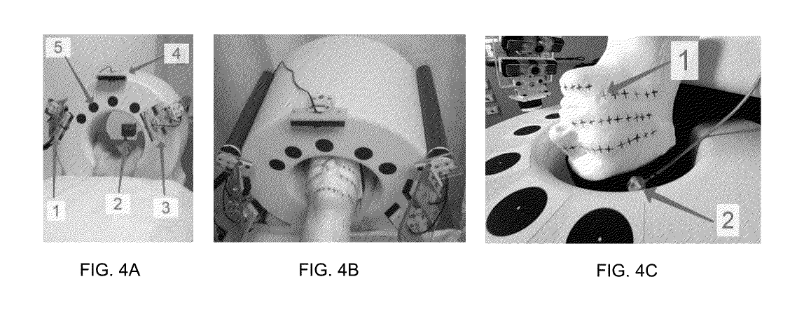

For system validation purposes, a mockup of a portable brain PET scanner was created. Five off-the-shelf wide angle (120°) Genius WideCam F100 (KYE Systems Corp., Taiwan) web cameras (640×480 pixels, up to 30 fps) and a 6 degree of freedom (DOF) magnetic tracking device (Polhemus Inc., USA) transmitter were mounted on it (FIGS. 4A-B). Four of the cameras were organized in two stereo pairs. They were calibrated beforehand using a checkerboard pattern to determine their intrinsic and extrinsic optical imaging parameters. The fifth camera was used for time synchronization purposes only.

FIGS. 4A-4C illustrate a scanner mockup which is an example of a tracking system designed in accordance with the disclosed embodiments and was used in the evaluation of the utility of such a tracking system. As shown in FIG. 4A, the scanner mockup includes a first stereo camera pair 1, a transmitter of the magnetic tracking device 2, a second stereo camera pair 3, a fifth camera for synchronization of the two laptops using a flash 4 and markers for calibration of the magnetic tracking device and the stereo reference frames 5. FIG. 4B illustrates the head phantom inside the mock scanner. FIG. 4C provides a view of the phantom head from one of the stereo tracking cameras, wherein the point that was tracked is illustrated at 1 and the magnetic tracking device sensor attached to the head with a headband is illustrated at 2.

The magnetic device included one transmitter and two receivers connected by wire to the electronic unit. The position (6 DOF) of the two receivers in the transmitter coordinate system was computed by the tracking system and could be read from an electronic unit with a computer via serial port. If the receiver was rigidly attached to a rigid object the position of that object could be computed in the coordinate system of the transmitter. A second transmitter was attached to the same object as the first one could be used for checking position data consistency.

The transformation from the two stereo coordinate systems to the magnetic tracking device reference frame was computed using set of points with coordinates known in coordinate systems of both stereo pairs and magnetic tracking device. A set of visual fiducial markers was attached to the scanner mockup (FIG. 4A). The markers were visible from all stereo cameras; therefore, their coordinates could be computed in the stereo reference frame. The coordinates of the markers were also computed in the magnetic tracking device reference frame using the following procedure. A stylus-like object was rigidly mounted to a receiver. The stylus tip was attached to the fiducial point and rotated around it while receiver position was recorded. All points of the stylus were rotating except the tip. Having that data the coordinate of the point was computed using an optimization algorithm Attaching the stylus tip to each visual fiducial point, its coordinates were computed in the transmitter reference frame.

Given coordinates of the correspondent points in two coordinate systems the transformation (rotation matrix R and translation vector t) could be computed. The translation t was computed as the difference between centroids of two corresponding point sets P¹={p₀¹, p₁¹, . . . , pₙ¹} and P²={p₀², p₁², . . . , pₙ²} (Eq. 1).

t=p_{c}¹−p_{c}² (1)

where p_{c} is a centroid of a point set P={p₀, p₁, . . . , pₙ},

$${p}_{c} = \frac{1}{N} {\sum }_{i} {p}_{i} . \qquad ( 2 )$$

When the centroids of both points set translated to the origin of the coordinate system (Eq. 3) the problem was reduced to finding the rotation R between two points sets Q¹, Q².

qᵢ=pᵢ−p_{c}. (3)

The rotation R was found using Singular Value Decomposition (SVD) of the 3×3 covariance matrix H. In matrix notation H computed with Eq. 4.

H=(Q¹)^{t}Q² (4)

where Q¹ and Q² are N×3 matrices containing coordinates of N corresponding points.

### If SVD of H is

H=USV^{t} (5)

then

R=VU^{t} (6)

Two laptop computers were used for recording the data. The first one was for video from the stereo cameras, while the second was for the data from the fifth camera and the magnetic tracking device. Data on each laptop was time-stamped. Time synchronization between laptops was performed by an external flash.

An experiment was performed with a styrofoam head model with optical fiducial markers consisting of a series of crosses (FIG. 4B). Two receivers of the magnetic tracking device were mounted on a headband attached to the phantom head. Video and magnetic tracking data were acquired with motion of the head phantom with facial point displacements of up to 50 mm Phantom head fiducial points on the video images were initialized manually by clicking on video frames. The coordinates of the initial points were computed in stereo reference frame and transformed to the reference frame of the magnetic tracking device. Then points were tracked independently on each of the four video sequences using an algorithm developed and described earlier, and in the magnetic tracking device reference frame using receivers attached to the head phantom.

In the future, human head tracking may use natural facial features. To quantify the error of the video tracking system, the mean and the standard deviation of the absolute difference between the coordinates of the fiducial points (n=6) were tracked by the magnetic tracking device and the stereo camera system were computed. Also, the mean and standard deviation of the Euclidean distance between ground truth and stereo tracked points were computed.

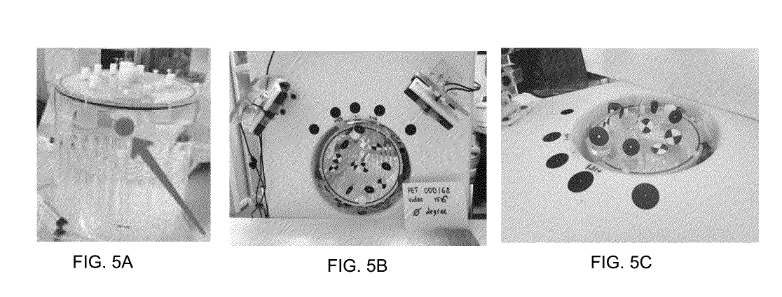

FIGS. 5A-5C illustrate an example of evaluation of performance of a motion tracking system was also estimated for a PET scan with a moving ACR phantom. FIG. 5A illustrates the ACR phantom with point sources attached (marked with arrow). FIG. 5B illustrates the experimental setup including PET scanner with two stereopairs and ACR phantom with visual fiducial markers. FIG. 5C illustrates a video frame grabbed from one of the tracking cameras.

The performance of the motion tracking system was estimated for a PET scan with a moving ACR phantom with ˜0.5 mCi of FDG and hot-cylinders-to-background ratio of 10:1. Three 1 μCi Na-22 point sources as well as visual fiducial markers were attached to the ACR phantom (FIGS. 5A-C). The specifications of the scanner are presented in Table 1. Three sets of data were acquired with the ACR phantom in different stationary positions: initial, rotated ˜15° counter-clockwise, rotated ˜15° clockwise. PET images for the three positions were reconstructed independently and combined into one image without motion correction and with motion correction using transformations derived from the video tracking system. For this prototype system, model-based attenuation correction was applied but not scatter correction.

TABLE 1
Specifications of the portable brain PET scanner.

| Description | Value | Units |
|---|---|---|
| Field of view (FOV), diameter | 22 | cm |
| FOV, axial | 22 | cm |
| Spatial resolution, center FOV | 2.1 | mm |
| Energy resolution, 511 keV | 15 | % |
| Intrinsic time resolution | 1 | ns |
| Open bore diameter | 25 | cm |
| Cerium-doped lutetium yttrium | 2 × 2 × 10 | mm³ |
| orthosilicate (LYSO) pixel dimensions | | |
| Number of LYSO crystals | 15 210 | |
| Number of photomultiplier tubes | 90 | |

The two stereopairs were calibrated beforehand and fixed to the scanner as for the head phantom study (FIGS. 5A-C). Another calibration was performed to find the transformation between the stereo camera coordinate system and the PET device. For that purpose, first, visual fiducial markers which can be seen from each stereo pair were attached to the gantry in the scanner field of view. Since the markers were seen in the cameras their coordinates can be computed in the stereo reference frames. Second, for computing the coordinates of the fiducial points in the PET reference frame, 1 μCi Na-22 point sources were attached to the fiducial markers and imaged in the PET scanner.

When coordinates of the same physical points are known in both the stereo and PET coordinate systems the transformation between them can be computed using method described above (Eq. 1-6). With a known transformation the position of the ACR phantom in the stereo coordinate system can be converted to the PET frame of reference.

The mean and standard deviation of the absolute differences as well as mean and standard deviation of the Euclidean distance between the ground truth magnetic tracking device measurements and the stereo camera measurements are presented in Table 2. The overall mean absolute difference between coordinates was in range 0.37-0.66 mm and the standard deviation was in range 0.4-0.77 mm. The overall mean Euclidean distance was 0.99±0.90 mm.

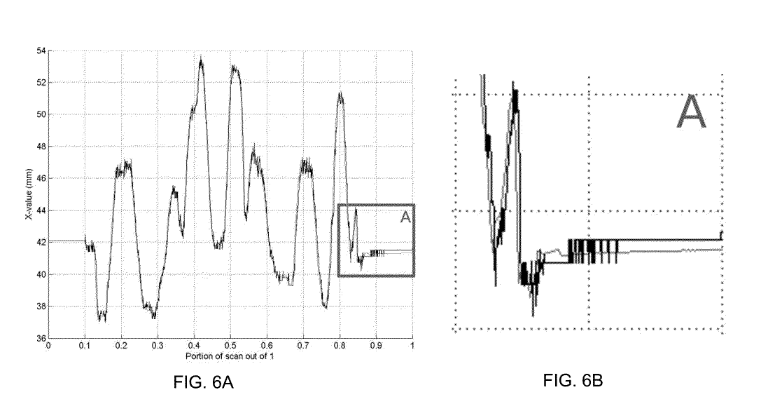

FIG. 6A illustrates the X-coordinate of a representative facial point computed with the stereo tracking system (dark) and the ground truth from a magnetic tracking device (light). The two graphs closely overlap due to the small difference in values. FIG. 6B illustrates an enlarged region of the graph of FIG. 6A marked with A. In FIGS. 6A-B, the graph of the X coordinate (dark) and the ground truth (light) for a representative facial point is presented. There is close agreement between these measurements.

TABLE 2
The mean absolute difference between the points coordinates
(X, Y, Z) tracked with the magnetic tracking device sensor
(ground truth) and the stereo camera system and mean Euclidean
distance (D) (mean ± standard deviation mm).

| Point | X, mm | Y, mm | Z, mm | D, mm |
|---|---|---|---|---|
| 1 | 0.52 ± 0.51 | 0.52 ± 0.54 | 0.40 ± 0.40 | 0.93 ± 0.75 |
| 2 | 0.32 ± 0.32 | 0.70 ± 0.78 | 0.39 ± 0.51 | 0.97 ± 0.89 |
| 3 | 0.26 ± 0.29 | 0.80 ± 0.88 | 0.44 ± 0.53 | 1.06 ± 0.97 |
| 4 | 0.48 ± 0.45 | 0.59 ± 0.63 | 0.45 ± 0.51 | 0.99 ± 0.80 |
| 5 | 0.27 ± 0.30 | 0.68 ± 0.87 | 0.43 ± 0.59 | 0.96 ± 0.99 |
| 6 | 0.35 ± 0.40 | 0.68 ± 0.81 | 0.49 ± 0.59 | 1.03 ± 0.97 |
| Overall | 0.37 ± 0.40 | 0.66 ± 0.77 | 0.43 ± 0.53 | 0.99 ± 0.90 |
| 1-6 | | | | |

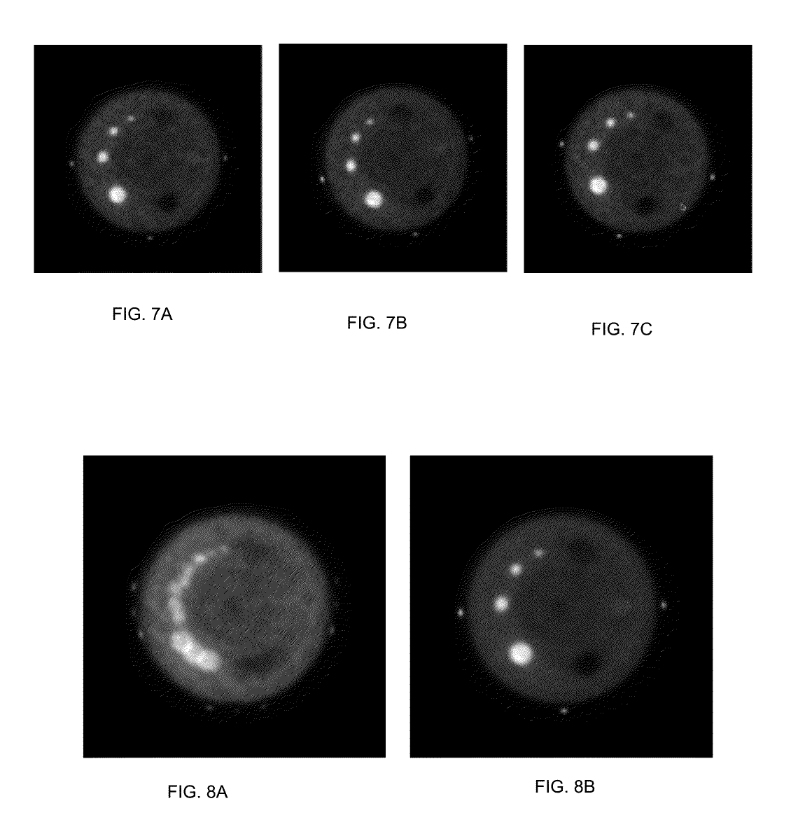

FIGS. 7A-7C illustrate an example of independently reconstructed PET images from acquisitions with different rotations gathered as part of experimental evaluation of an exemplary implementation of a system designed in accordance with the disclosed embodiments.

The independently reconstructed PET images from acquisitions with different rotations are shown in FIGS. 7A-C. FIG. 7A illustrates an initial position of the phantom. FIG. 7B illustrates rotation by ˜15° anti-clockwise. FIG. 7C illustrates rotation by ˜15° clockwise.

FIGS. 8A-8B illustrate combination of the images into one image without motion compensation (FIG. 8A) and one with (FIG. 8B. There is obvious blurring in combined image without motion compensation. The six degree of freedom pose information from the stereo motion tracking system was used for aligning images to the initial position of the phantom. These images were combined into one image without motion compensation, as illustrated in FIG. 8A. There is obvious blurring in this image. The aligned images were combined into one with compensated motion as illustrated in FIG. 8B. The six degree of freedom pose information from the stereo motion tracking system was used for aligning images to the initial position of the phantom.

Based on the experimental data, a stereo video camera tracking system provided in accordance with the disclosed embodiments enables tracking of facial points in 3D space with a mean error about 0.99 mm. The advantage of motion correction is clearly seen from the ACR phantom study. Such a system can help to preserve the resolution of PET images in the presence of unintentional movement during PET data acquisition. A more comprehensive study with human subjects to assess the performance of the tracking system will be performed.

Further technical utility of the disclosed embodiments is evidenced and analyzed in S. Anishchenko, D. Beylin, P. Stepanov, A. Stepanov, I. N. Weinberg, S. Schaeffer, V. Zavarzin, D. Shaposhnikov, M. F. Smith M3D2-7, Markerless Head Tracking Evaluation with Human Subjects for a Dedicated Brain PET Scanner. Presentation at the 2015 IEEE Nuclear Science Symposium and Medical Imaging Conference. San Diego, Calif., USA, Oct. 31-Nov. 7, 2015, (incorporated by reference in its entirety) wherein imaging of human subjects is discussed in depth.

While the disclosed embodiments have been shown and described, it will be understood by those skilled in the art that various changes in form and details may be made thereto without departing from the spirit and scope of the present disclosure as defined by the appended claims.

For example, the above method for performing motion-corrected imaging and the corresponding imaging system may be applied/adapted for other imaging techniques such as x-ray computed tomography, magnetic resonance imaging, 3-D ultrasound imaging. The above methods and systems may be adapted and/or employed for all types of nuclear medicine scanners, such as: conventional PET, PET-CT, PET-MRI, SPECT, SPECT-CT, SPECT-MRI scanners. The PET system may be a Time-Of-Flight (TOF) PET. For imaging systems employing planar SPECT the motion information may be two-dimensional motion information. The above systems and methods may be used to image any moving object, animate (plant or animal or human) or inanimate. The above system may be used to form a motion-corrected imaging for a portable brain PET imager.

Disclosed embodiments provide technical utility over conventionally available intrinsic feature-based pose measurement techniques for imaging motion compensation in a number of different ways. For example, disclosed embodiments enable tracking of specific facial features (e.g., corner of the eye) as a function of time in a stereo camera pair; as a result, the same feature may be tracked (or attempted to be tracked) in every image. This can reduce or mitigate a source of error that may result from extracting and tracking intrinsic features in one camera at a time. Disclosed embodiments have additional technical utility over such conventional systems because the disclosed embodiments do not require application of a correspondence algorithm to determine which intrinsic features are common to both cameras and which can be used for head pose determination. Conventional imaging motion compensation techniques that extract and track intrinsic features in one camera at a time require application of such an algorithm because, there could be different numbers of intrinsic features in images from the same camera as a function of time before intrinsic feature editing or there could be different numbers of intrinsic features in images from different cameras at the same time point. Accordingly, the disclosed embodiments provide a technical solution to this conventional problem by tracking specific facial features as a function of time in a stereo camera pair.

Further, disclosed embodiments provide technical utility over the conventional art by performing tracking that involves computation of directional gradients of selected features and determination of where there is a high similarity close by and in the next image to assess how the feature has moved in time.

Disclosed embodiments also can compute the head motion of a subject in the PET scanner reference frame, not just with respect to an initial head position, but with respect to the head position at any arbitrary reference time (could be first, last or in the middle); subsequently, a transformation may be applied to determine the head position in the PET scanner reference frame. This enables improved image reconstruction so as to eliminate blur resulting from movement. Further, disclosed embodiments can relocate PET LORs for image reconstruction. Moreover, fiducial points on the scanner and intrinsic features on the patient head can be tracked as a function of time. This enables robust pose calculation in case a camera is bumped by the patient and its position is disturbed. Viewing the fiducial points on the scanner essentially enables the camera to PET scanner reference frame to be continuously monitored for possible inadvertent camera motion.

It should be understood that the operations explained herein may be implemented in conjunction with, or under the control of, one or more general purpose computers running software algorithms to provide the presently disclosed functionality and turning those computers into specific purpose computers.

Moreover, those skilled in the art will recognize, upon consideration of the above teachings, that the above exemplary embodiments may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Furthermore, it should be understood that control and cooperation of disclosed components may be provided via instructions that may be stored in a tangible, non-transitory storage device such as a non-transitory computer readable storage device storing instructions which, when executed on one or more programmed processors, carry out the above-described method operations and resulting functionality. In this case, the term non-transitory is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of various different entities or individuals.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

As a result, it will be apparent for those skilled in the art that the illustrative embodiments described are only examples and that various modifications can be made within the scope of the invention as defined in the appended claims.

What is claimed is:

1. A medical imaging system comprising:
an imaging apparatus configured to acquire a plurality of data points or image frames corresponding to events taking place in an object disposed in the imaging apparatus;
a marker-less tracking system configured to determine, simultaneous with the acquisition of the plurality of data points or the image frames, a position and motion of the object with respect to the imaging apparatus;
an image correction unit configured to correct the data points or the image frames so as to remove the artifacts due to the motion of the object during the acquisition of the data points of the frames, and
an image forming unit configured to receive the corrected data points or frames from the image correction unit and to form a corrected image by using an image reconstruction algorithm or by combining the reconstructed image frames.

2. The medical imaging system of claim 1 wherein the marker-less tracking system comprises two pairs of stereo video cameras.

3. The medical imaging system of claim 2, wherein the two pairs of stereo video cameras both generate image data which is analyzed by the image correction unit to tracks at least one specific facial feature as a function of time.

4. The medical imaging system of claim 2 wherein the distance between cameras in each of the two pairs is smaller than the distance between the cameras in different pairs.

5. The medical imaging system of claim 2 wherein the first pair of stereo cameras is configured to form a first stereo 3D image and the second pair of stereo camera is configured to form a second stereo 3D image.

6. The medical imaging system of claim 1 wherein the imaging apparatus is a PET scanner and each data point comprises information about a single line of response.

7. The medical imaging system of claim 1 wherein the marker-less tracking system is configured to automatically identify three or more intrinsic features of the object.

8. The medical imaging system of claim 1 wherein the marker-less tracking system is configured to enable an operator to select, via an input device, from an image of the object displayed on a computer display three or more intrinsic features of the object.

9. A medical imaging method comprising:
calibrating the positions of an imaging apparatus and a system of cameras;
placing the object to be imaged in an imaging-volume of the imaging apparatus;
receiving, at the imaging apparatus, a plurality of data points or image frames corresponding to the object during an imaging period;
continuously tracking the motion of the object during the imaging period by a marker-less tracking system;
correcting individual image frames or data points for the motion of the object; and
forming a motion-corrected image of the object.

10. The medical imaging method of claim 9 wherein the marker-less tracking system comprises two pairs of stereo video cameras.

11. The medical imaging method of claim 10, wherein the two pairs of stereo video cameras both generate image data which is analyzed by the image correction unit to track at least one specific facial feature as a function of time.

12. The medical imaging method of claim 10, wherein the distance between cameras in any of the two pairs is smaller than the distance between the cameras in different pairs.

13. The medical imaging method of claim 10, wherein the first pair of stereo cameras is configured to form a first stereo 3D image and the second pair of stereo camera is configured to form a second stereo 3D image.

14. The medical imaging method of claim 9, wherein the imaging apparatus is a PET scanner and each data point comprises information about a single line of response.

15. The medical imaging method of claim 9, wherein the marker-less tracking system is configured to automatically identify three or more intrinsic features of the object.

16. The medical imaging method of claim 9, wherein the marker-less tracking system is configured to enable an operator to select, via an input device, from an image of the object displayed on a computer display three or more intrinsic features of the object.
